(19) United States
(12) Patent Application Publication
(10) Pub. No.: US 2026/0154105 A1
(43) Pub. Date: Jun. 4, 2026

(54) CLEAN SLATE APPLICATION TRANSFORMATION WITH TRANSPARENT LEGACY SYSTEM ACCESS

(71) Applicant: SAP SE, Walldorf (DE)

(72) Inventors: Peter Eberlein, Malsch (DE); Volker Driesen, Heidelberg (DE)

(21) Appl. No.: 18/966,745

(22) Filed: Dec. 3, 2024

(51) Int. Cl. G06F 9/48; G06F 9/445

(52) U.S. Cl. CPC G06F 9/485; G06F 9/44505

(57) ABSTRACT

A computer-implemented method for clean slate application transformation with transparent legacy system access, includes configuring an access and integrate legacy system (AILS) legacy data access module for access to a legacy application. Master data migration of a required subset of master data to a target application is triggered. Using the AILS legacy data access module and an AILS user interface (UI) widget in a target application UI, switching usage to the target application. Using the AILS legacy data access module and the AILS UI widget, closing usage of the legacy application for changes. The legacy application is decommissioned.

### BACKGROUND

For applications used by corporations or large organizations and that store alphanumeric data and text related documents and with a broad scope (such as, enterprise resource planning (ERP) and customer relationship management (CRM)), a vendor will, from time-to-time, perform a major re-design or re-platforming of the application to keep up to date with software platforms, take advantage of new platform as a service (PaaS) offerings, new database technologies, etc. With such a major re-design, a vendor will not provide the exact same functionality again on the new platform, but will modernize the application as well, adjust scope, data organization, configuration, and extension options.

Typically, a vendor will want to offer not only “green field” data onboarding to all customers but support existing customers with a “brown field” approach, including data migration to ease onboarding for users of the earlier product. Such data migrations are not possible without the intensive support of the customer (e.g., decide on scope, adjust data, especially inconsistent data, and configure the new application), therefore causing additional effort for customers. A migration project with accompanied costs can trigger an analysis by the customers, and if an alternative target product may be more cost effective or even functionally superior—considering that a migration to a new product and a costly migration project is required anyways—unless there is an advantage to stay with the new platform, the customers may instead choose the alternative target product.

### SUMMARY

The present disclosure describes clean slate application transformation with transparent legacy system access.

In an implementation, a computer-implemented method for clean slate application transformation with transparent legacy system access, comprises: configuring an access and integrate legacy system (AILS) legacy data access module for access to a legacy application; triggering master data migration of a required subset of master data to a target application; switching, using the AILS legacy data access module and an AILS user interface (UI) widget in a target application UI, usage to the target application; closing, using the AILS legacy data access module and the AILS UI widget, usage of the legacy application for changes; and decommissioning the legacy application.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages.

### Compared to Software Migration.

Software migration is, even if supported by the vendor with automated migration tools, a big and costly project for a company using the software. Typically, used scope, configuration and partially even transactional data needs to be adjusted to match the target solution. Then, there is often an application downtime during migration, which disrupts a customer's business - all of this causes costs and effort, business experts at the customer need to be involved in the migration project instead of performing their regular business tasks. Finally, customers take over lots of legacy data into their new systems that they rather would get rid of but need to keep accessible for various reasons. This prevents a fresh start on a clean new system.

The described approach for a new “clean slate transformation” resolves these problems:
The new application can be set up and starting point of usage can be defined by business—there is no downtime.
There is also no manual effort to adjust inconsistent transactional data in the legacy system before migration.
The new application can be configured and scope defined exclusively based on current needs and with no regards to previous decisions that are no longer valid.
The overall project effort will be smaller and the business impact reduced.

Compared to software migration and mechanisms on the start release side to reduce data volume.
Selective data migration is permitted.
Data reduction using archiving—when using a solution to reduce data in the application (mainly reducing old documents), there are several obstacles:
   The team executing the migration project has to configure the archiving/data migration conditions—which key ranges to take over, and which to leave behind. This configuration needs to be consistent from a line of business (LoB) point-of-view (a technical consistency will be achieved by the tool)—the key ranges still desired for different objects and the key ranges with the largest data volume need to be analyzed and a decision needs to be negotiated, what to take/leave behind from the different LoBs.
   The team introducing and running archiving/selective data migration needs to negotiate with the line of business as to which data they can archive, because the data is afterwards only visible through the archiving solution and not directly in the application system with all (read-only) application functions like fast viewing, search, computing aggregates, analytics, usage for ML, etc.

The new “clean slate transformation” approach resolves these obstacles. The point-in-time when the target application is introduced marks mainly the time to create new objects in the target application and to only complete objects in the legacy application. Access to legacy data is eased (and integrated). The application provides the desired fast search, analytics, building aggregates, etc. There are no compromises from data being archived.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flow diagram illustrating an example of a high-level procedure flow for a clean slate transformation, according to an implementation of the present disclosure.

FIG. 2 is a box diagram of an access and integrate legacy system (AILS) module providing transparent legacy system access, according to an implementation of the present disclosure.

FIG. 3 is a flowchart illustrating an example of a computer-implemented method for clean slate application transformation with transparent legacy system access, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes clean slate application transformation with transparent legacy system access and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

For the purposes of this disclosure, a “legacy application” is an application a customer is using when the described approach is started. The desired target application version is a “target application.” The described approach is a methodology to transform a company's use of a legacy application to a new target application by taking a “clean slate approach” using an application “add-on,” which enables a transformation with continuous operation and a gradual transfer of process use from a legacy application to a target application.

The approach establishes a single user interface (UI) approach covering single business document screens, as well as list views and aggregating UIs for data residing in the legacy or in the target application. The users of the application have a one-stop experience while the data is being managed in the two systems (i.e., containing the legacy application and the target application), and use and data storage gradually moves towards the target application. Audit and compliance aspects are ensured, and embedded analytics of business warehouse integrations can be supported. For the customer, this means a start on a clean slate with a fresh implementation project on the target application, with no compromises in business configuration just for the sake of enabling migration of legacy data, as this data can remain seamlessly accessible in the legacy application.

For applications used by corporations or large organizations and that store alphanumeric data and text related documents and with a broad scope (such as, enterprise resource planning (ERP) and customer relationship management (CRM)), a vendor will, from time-to-time, perform a major re-design or re-platforming of the application to keep up to date with software platforms, take advantage of new platform as a service (PaaS) offerings, new database (DB) technologies, etc. With such a major re-design, a vendor will not provide the exact same functionality again on the new platform, but will modernize the application as well, adjust scope, data organization, configuration, and extension options.

Typically, a vendor will want to offer not only “green field” data onboarding to all customers but support existing customers with a “brown field” approach, including data migration to ease onboarding for users of the earlier product. Such data migrations are not possible without the intensive support of the customer (e.g., decide on scope, adjust data, especially inconsistent data, and configure the new application), therefore causing additional effort for customers. A migration project with accompanied costs can trigger an analysis by the customers, and if an alternative target product may be more cost effective or even functionally superior—considering that a migration to a new product and a costly migration project is required anyways—unless there is an advantage to stay with the new platform, the customers may instead choose the alternative target product.

A vendor will therefore want to ensure that existing customers can onboard to the new solution easily. Best, additional streamlining benefits of adoption the new application can be provided, so customers not only take advantage of the new product and its functionality, but, e.g., can reduce complexity and volume of a legacy data stack and reduce customizing efforts and data volume in the application, which typically leads to lower ongoing costs (e.g., lower data volume typically results in lower need for disk storage, memory, CPU to process data, and faster search).

Application vendors offer different solutions for migrations:
Full database DB—a mainly automated procedure migrating all data.
Selective data migration—after customer configuration of the data to migrate again a mainly automated procedure.

However, both data migration procedures result in a large-scale project at the customer using the former product to adjust scope, perform customizing, and train users on the new product. One major task includes data-clean-up to fit legacy, maybe even partially inconsistent, data in complex and often customized data structures into new—likely more optimized and therefore constrained—data models. Finally, data migration procedures will result in application downtime for the customer leading to further inconveniences.

Using an upgrade or migration procedure by the vendor will try to keep as much of a company's business configuration and potentially even extensions and transfer this to the target application. Having used an application for a long time, companies have accumulated a lot of processes and extensions, which are potentially outdated, no longer needed and companies would like to get rid of them. Typically, it is very hard to understand legacy configurations and extensions, as these have often been created by consulting firms years ago and no employee of the company knows them exactly. It is therefore “software archeology” required to identify what to take and what to revert. This leads to another big effort driver in migration projects. Having a new application permits a company to start fresh again, taking advantage of new standard offerings by the new application and putting new business needs into the center of the new configuration, instead of analyzing the legacy, identifying what still matches needs, and revoking unnecessary legacy extensions.

### Problem Description.

Data migration to a new application version is accompanied with manual effort and downtime.

Typical, full data migration is required when data models and application scope change and, in cases when the data does not fit 100% into the new application, decisions by the customer are required. Often an expert user by the LoB using the application is required to solve such actions, not a central administrator. This makes the related projects at a customer “big,” as many departments are involved and need to be coordinated with.

Data migration is also often resulting in downtime—even if there is an “incremental migration,” final completion and review activities are required offline. The data in the target also needs to be tested, at least to a certain extend during a live cut-over.

A decision, which data to migrate, which to delete, archive, or leave in the legacy application is cumbersome and controversial and involves decision making of the LoB using the application.

A customer may want to reduce the data set to be migrated to the new application due to one or other reasons: 1) migrating a smaller data set is typically faster; 2) requires fewer manual activities (see previous point); and 3) results in a smaller target application, which is less costly to run or lease.

Selection of data to delete, archive or leave in kept legacy applications requires decisions by LoB leaders and typically experts on legal aspects for auditing etc. When data is deleted which is required for auditing purpose, this can cause severe problems for a customer. If data is archived, it is OK for audit, but inconvenient to access—and if access is required frequently, users will be annoyed. If data with open positions is archived (probably archiving rejects such data) or deleted, the business process to close such positions cannot be completed any longer.

Customers want to start fresh with a new application, reaping all benefits from the new application and enhanced functionality and to replace legacy custom code and data structures with new standard processes to reduce maintenance efforts. As business processes evolve over time in the industry, customers want to follow the new best practices and not be held back by the question on how to migrate their legacy data to the new (target) world. They cannot just get rid of all their legacy data, as they still need to be accessible to continue their business and fulfill legal requirements. But they would rather want to start from scratch with all new transactions, working a in a clean and a standardized as possible application. They would only get back to their legacy data in exceptional cases and benefit from a fresh start without legacy burdens as much as possible.

### Approach and Procedure.

What customers would love to do is start with a clean slate. So, the approach is to replace data migration by a federated data access approach using a legacy application and a target application in parallel. The federated use is managed by an “access and integrate legacy system” (AILS) module provided in the target application. Master data either being managed by a master data integration system (MDI) or by selectively migrating only master data to the target application. All other data remains in the legacy application and customers can start with the new application on a clean slate.

The idea establishes a usage, when at some point-in-time, the target application is opened for access by the users and the legacy application is closed for direct consumption. From this point-in-time onward, access is managed using the target application, and if the legacy application is accessed, the AILS module facilitates the access. New transaction data is created only with the target application. If existing workflows need to be completed (requiring changes to existing documents), the AILS embeds the UI of the legacy application for these documents. For overview UIs listing data from a legacy application and a target application, the list view is populated with data using two calls, that is to the legacy application and the target application. Navigation to items in the list then calls the respective system hosting the record.

Activities spanning data in legacy applications and target applications are distributed (e.g., a dunning run is started on both the legacy application and the target application and results are displayed jointly, aggregates can be computed with data from the aggregates in the two systems). For analytics, the data is fetched from two systems and aggregated for display in one UI. For audit purposes (e.g. a financial period is either provided using the legacy application completely, by both or finally only by the target application).

The legacy application is used for a certain period to close open documents, and, at some point, the legacy application is mainly used as read-only for legacy data access or analysis. This access typically decreases over time. At some point, the legacy application is not required for audit purposes any longer and the customer can decide to decommission the legacy application completely. This is potentially after many years, but as the legacy application is put into full maintenance mode that is only occasionally accessed remotely to deliver some legacy data, it does not create much cost, and is therefore cheaper than the cost would be for migrating all the data to the target application.

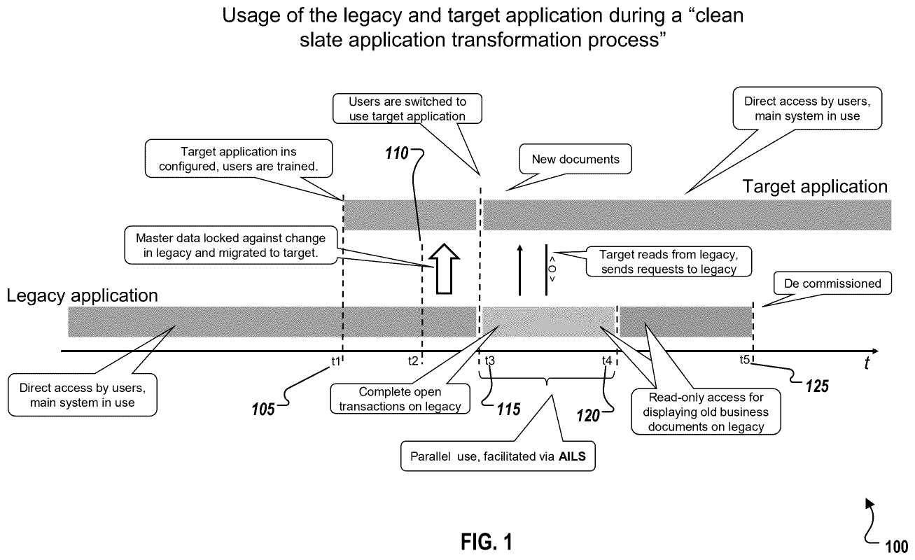

FIG. 1 is a flow diagram illustrating an example of a high-level procedure flow 100 for a clean slate transformation, according to an implementation of the present disclosure.

### Procedure.

When a vendor releases a successor product (i.e., a target application) of a legacy application, at some point a customer will decide to use the target application. The provider creates a tenant for the customer and provides access. The procedure steps are:
At t1 105, an administrator of a customer receives access to a target application tenant and prepares for production use. The administrator, together with the specialists of the LoB which will use the product, configures the target application to their needs as if this was a first-time onboarding without any consideration of the legacy application that they are already using. Additionally, the administrator configures the target application AILS for access to the legacy application, so that they do not need to worry about aligned business processes or migrating transactional data.

At t2 110, the administrator of the customer starts a master data migration. The administrator triggers master data migration of a required subset of master data. Alternatively, if a master data integration solution is used by the customer, the administrator configures the new target application to participate in master data integration. Note, between t2 110 and t3 115, master data origin is still in the legacy application and can be changed there.

At t3 115, usage is switched to the target application, where users obtain access to the new product version.
Master data is opened for maintenance in the target application and is locked against changes in the legacy application.
Access from target application to legacy application is facilitated using AILS and the AILS UI widget.
Users now login to the UI of the target application, the legacy application is locked for direct login (except for auditors).
User requests to create new business documents are processed by the target application.
User requests to complete open transactions on existing business documents are routed to the legacy application by UI embedding.
List views query the data from target and legacy application (depending on the filter criteria of the list view. Navigation to business documents originating from the legacy application are routed to the legacy application by UI embedding.
Aggregating transactions query data from target and legacy applications, aggregate the received values and display the combined results on the target UI.

At t4 120, usage of the legacy application is closed for changes and only available read-only (e.g., for audits).
The admin decides after consultation with the LoB experts to close the legacy application against changes.
This can be supported by statistics at AILS, how many open transactions are remaining in the legacy application.
AILS is configured to only send read requests to the legacy application.
AILS is configured to not provide UI navigation to the legacy application for change operations.
The legacy application is configured to serve read-only only. This reflects on the UI and on incoming application programming interface (API) calls.

At t5 125, a need to keep the legacy data ends and the application is decommissioned.
At some point, the data required for legal audits is available completely in the target application.
From this point on, the legacy application is only needed, if a customer LoB unit occasionally requires the data, which now can also be accomplished by archiving still needed data to an external system.
When neither legal nor LoB need the data in the system, the legacy application is decommissioned.

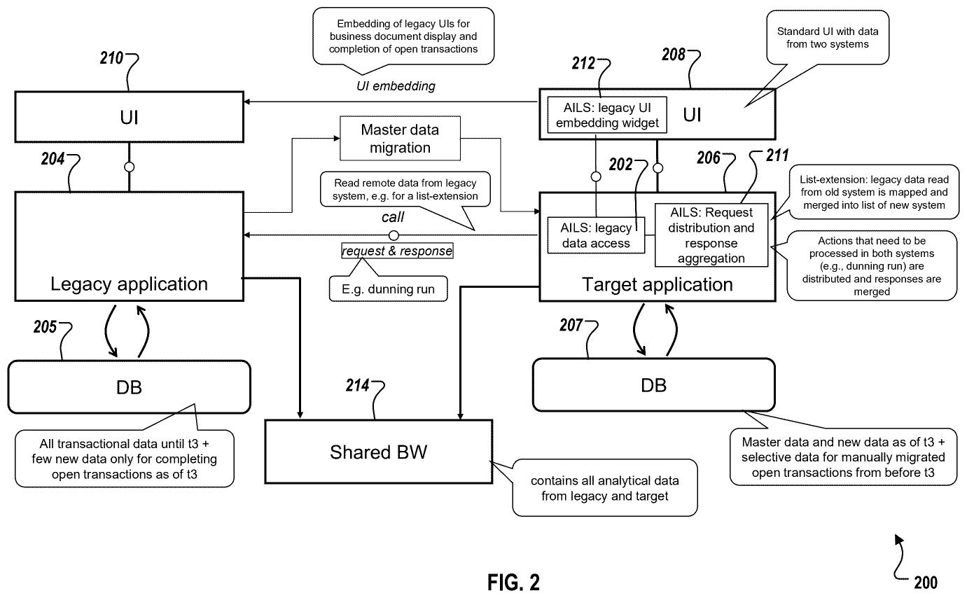

FIG. 2 is a box diagram 200 of an AILS module providing transparent legacy system access, according to an implementation of the present disclosure.

In the described approach, the AILS 202 enables a clean slate application transformation with transparent legacy application 204 (and associated legacy DB 205) access, and is built into a target application 206 (and associated DB 207), which facilitates access to the legacy application 204. Note that the AILS 202 can be separated into one or more components providing AILS 202 functionality (e.g., within the target application 206 and associated target application UI 208.

In some implementations, the AILS 202 supports four primary types of actions:
1) Single business document display and (e.g., depending on status and procedure step) modification:
While new objects (objects being created after t3 (FIG. 1, 115)) are managed entirely in the target application 206, for objects existing in the legacy application 204, AILS 202 redirects display requests to the legacy application UI 210.
The documents that are still in status “open transaction” need to be completed in the legacy application 204. For these documents, modifications are also possible. With this capability, users can either finish the business transaction or split/cancel it and manually create corresponding new business documents/start a new business process on the target application 206.
The legacy application UI 210 (both for display and modification) is embedded into the target application UI 208 using an AILS “remote widget” 212.
When an object is selected or requested to be displayed or modified, AILS 202 determines, if the object is stored in the legacy application 204 or the target application 206 and in case it is stored in the legacy application 204, calls the respective legacy application UI 210. This provides seamless access no matter where the business document resides, and it also allows for major differences in a UI and data structure, as no alignment or migration is needed.
2) List view with filtering and search:
Applications typically have list views in tabular form showing (e.g., key records of) many objects/business documents. This is mainly used to get an overview or to find a desired object to navigate to.
List views therefore have filtering options on the columns/attributes and search capabilities (e.g., for strings or patterns in fields of the list).
The list view can display attributes of objects retrieved from the legacy application 204 and the target application 206. For this, attributes of the legacy application 204 are mapped in the AILS 202 to corresponding attributes in the target application 206 (e.g., using the AILS: request distribution and response aggregation 211).
When navigating from the list entry to the document, the legacy application UI 204 or the target application UI 206 are embedded (see previous point).
Records in the list (depending on filter criteria and “show more” selection) are retrieved from the legacy application 204 and the target application 206 in parallel and then merged into one UI for seamless access by the user (e.g., using the AILS: request distribution and response aggregation 211).
3) Aggregating actions and actions on a multitude of objects.
Some actions in an application act on data of several application objects or documents.
For such actions, data is retrieved from the legacy application 204 and the target application 206.
For actions performing follow-up operations, the action is called by AILS 202 on both, the legacy application 204 and the target application 206.
The results of such actions are shown in the target application UI 206. The action in the legacy application 204 can modify data locally, potentially even perform external communication (e.g., send data for document rendering).
An example is a “dunning run in an application.” This refers to the process of sending reminders to customers for overdue payments. It is a part of an accounts receivable management process, and it helps in ensuring that customers are reminded to pay their outstanding invoices on time. Invoices in the legacy application 204 that have not yet been paid in full still need to be included in a dunning run, therefore this operation is executed in both the legacy application 204 and the target application 206 in parallel, each covering only invoices located in the respective applications (e.g., using the AILS: request distribution and response aggregation 211).
4) Embedded analytics—modern applications have embedded analytics capabilities. These can be provided using AILS 202 as well:
Data from periods until t3 (FIG. 1, 115) are only stored in the legacy application 204, the data is therefore solely read from the legacy application 204,
Data from periods as of t4 (FIG. 1, 120) are only stored in target application 206, the data is read from the target application 206.
For period t3 (FIG. 1, 115) to t4 (FIG. 1, 120), documents may be written in the legacy application 204 and the target application 206, depending on where the business process had started. For analytics and aggregated values, the data for this transition period is therefore read from both, the legacy application 204 and the target application and is aggregated in AILS 202.
An example is order volume per time period. Orders being created for processes started after t3 (FIG. 1, 115) are stored in the target application 204, orders related to processes started before t3 (FIG. 1, 115) are completed in the legacy application 204. The order volume for a period in the time range t3 (FIG. 1, 115) to t4 (FIG. 1, 120) is therefore an aggregate of data from the legacy application 204 and the target application 120. Both applications can provide the data and this is then aggregated by AILS 202.

Central shared Business Warehouse (BW) 214. If a legacy application 204 had been integrated with a BW solution, and the target application 206 will be integrated into the same BW solution, then the data in a backend has a unique origin, it is either residing in a legacy application 204 or a target application 206. A BW 214 can therefore show the superset of the information, the legacy application 204 will out-date by itself over time. In an AILS 202 shared BW scenario, for analytics calls, AILS 202 accesses the BW 214 directly, it does not call the legacy application 204 additionally, as the BW 214 already contains legacy data from the legacy application 204 in addition to new data from the target application 206.

External system (not illustrated). A legacy application 204 can still call existing external systems (outgoing), as long as business transactions need to be completed (until t4—FIG. 1, 120). Incoming calls from external systems should only affect new business transactions and are therefore reconfigured to go only to the target application 206 after t3 (FIG. 1, 115).

### Advantages.

Compared to software migration:
Software migration is, even if supported by the vendor with automated migration tools, a big and costly project for a company using the software. Typically, used scope, configuration and partially even transactional data needs to be adjusted to match the target solution. Then, there is often an application downtime during migration, which disrupts a customer's business—all of this causes costs and effort, business experts at the customer need to be involved in the migration project instead of performing their regular business tasks. Finally, customers take over lots of legacy data into their new applications that they rather would get rid of but need to keep accessible for various reasons. This prevents a fresh start on a clean target application.

The described approach for a new “clean slate transformation” resolves these problems:
The new application can be set up and starting point of usage can be defined by business—there is no downtime.
There is also no manual effort to adjust inconsistent transactional data in the legacy application before migration.
The new application can be configured and scope defined exclusively based on current needs and with no regards to previous decisions that are no longer valid.
The overall project effort will be smaller and the business impact reduced.

Compared to software migration and mechanisms on the start release side to reduce data volume:
Selective data migration is permitted.
Data reduction using archiving-when using a solution to reduce data in the application (mainly reducing legacy documents), there are several obstacles:
   The team executing the migration project has to configure the archiving/data migration conditions—which key ranges to take over, and which to leave behind. This configuration needs to be consistent from a line of business (LoB) point-of-view (a technical consistency will be achieved by the tool)—the key ranges still desired for different objects and the key ranges with the largest data volume need to be analyzed and a decision needs to be negotiated, what to take/leave behind from the different LoBs.
   The team introducing and running archiving/selective data migration needs to negotiate with the LoB as to which data they can archive, because the data is afterwards only visible through the archiving solution and not directly in the application with all (read-only) application functions like fast viewing, search, computing aggregates, analytics, usage for machine learning (ML), etc.

The new “clean slate transformation” approach resolves these obstacles. The point-in-time when the target application is introduced marks mainly the time to create new objects in the target application and to only complete objects in the legacy application. Access to legacy data is eased (and integrated). The Application provides the desired fast search, analytics, building aggregates, etc. There are no compromises from data being archived.

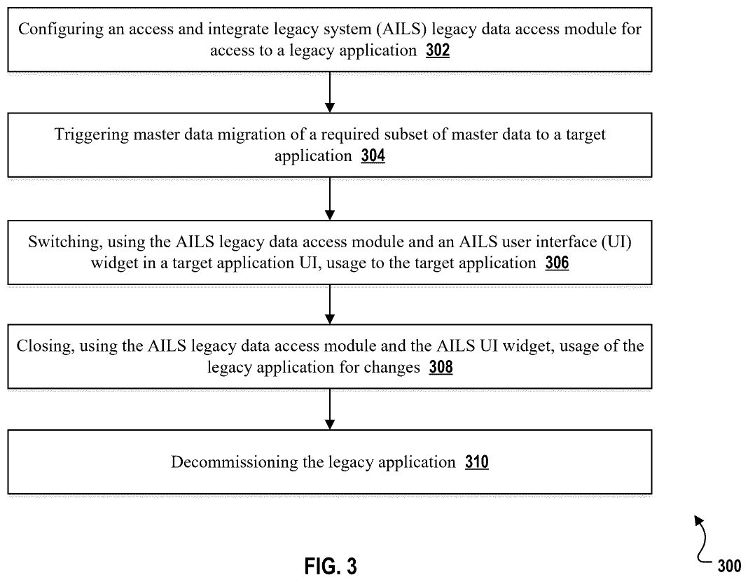

FIG. 3 is a flowchart illustrating an example of a computer-implemented method 300 for clean slate application transformation with transparent legacy system access, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, an access and integrate legacy system (AILS) legacy data access module for access to a legacy application is configured. In some implementations, access to the target application is received, the target application is prepared for production use, and the target application is configured as if a first-time onboarding without consideration of the legacy application. From 302, method 300 proceeds to 304.

At 304, master data migration of a required subset of master data to a target application is triggered. In some implementations, during master data migration of a required subset of master data to a target application, the required subset of master data is locked in the legacy application against change. From 304, method 300 proceeds to 306.

At 306, using the AILS legacy data access module and an AILS user interface (UI) widget in a target application UI, switching usage to the target application.

In some implementations, switching usage to the target application, includes: 1) opening, in the target application, master data for maintenance; 2) providing, using the AILS legacy data access module and an AILS UI widget in the target application UI, access from the target application to the legacy application; 3) locking login to the legacy application; 4) routing user requests to complete open transactions to the legacy application by UI embedding; 5) routing navigation to documents originating from the legacy application to the legacy application with UI embedding; and 6) aggregating, as aggregated data and using an AILS request distribution and response aggregation module, transaction query data from the target application and the legacy application, wherein the aggregated data is displayed on the target application UI. From 306, method 300 proceeds to 308.

At 308, using the AILS legacy data access module and the AILS UI widget, closing usage of the legacy application for changes. In some implementations, closing usage of the legacy application for changes, comprises: 1) configuring the AILS legacy data access module to send requests to the legacy application; 2) configuring the AILS UI widget to not provide UI navigation to the legacy application for change operations; and 3) configuring the legacy application to read-only configuration, wherein the configuration is reflected at least in a legacy application UI and incoming application programming interface (API) calls. From 308, method 300 proceeds to 310.

At 310, the legacy application is decommissioned once a determination is made that data from the legacy application is no longer needed (e.g., by a legal group or a line of business). After 310, method 300 can stop.

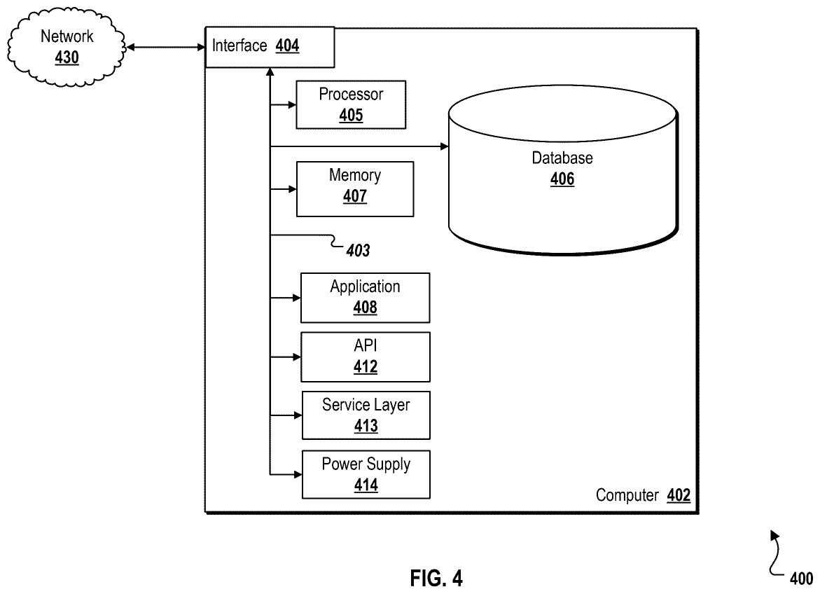

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, computer-implemented system 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 406 that can hold data for the Computer 402, another component communicatively linked to the Network 430 (whether illustrated or not), or a combination of the Computer 402 and another component. For example, Database 406 can be an in-memory or conventional database storing data consistent with the present disclosure. In some implementations, Database 406 can be a combination of two or more different database types (for example, a hybrid in-memory and conventional database) according to particular needs, desires, or particular implementations of the Computer 402 and the described functionality. Although illustrated as a single Database 406, two or more databases of similar or differing types can be used according to particular needs, desires, or particular implementations of the Computer 402 and the described functionality. While Database 406 is illustrated as an integral component of the Computer 402, in alternative implementations, Database 406 can be external to the Computer 402. The Database 406 can hold and operate on at least any data type mentioned or any data type consistent with this disclosure.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user-or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features, alone or in combination.

For example, in a first implementation, a computer-implemented method for clean slate application transformation with transparent legacy system access, comprising: configuring an access and integrate legacy system (AILS) legacy data access module for access to a legacy application; triggering master data migration of a required subset of master data to a target application; switching, using the AILS legacy data access module and an AILS user interface (UI) widget in a target application UI, usage to the target application; closing, using the AILS legacy data access module and the AILS UI widget, usage of the legacy application for changes; and decommissioning the legacy application.

The foregoing and other described implementations can each, optionally, include one or more of the following features:
A first feature, combinable with any of the following features, comprising: receiving access to the target application; preparing the target application for production use; and configuring the target application as if a first-time onboarding without consideration of the legacy application.
A second feature, combinable with any of the previous or following features, comprising: during master data migration of a required subset of master data to a target application, locking the required subset of master data in the legacy application against change.
A third feature, combinable with any of the previous or following features, wherein switching usage to the target application, comprises: opening, in the target application, master data for maintenance; providing, using the AILS legacy data access module and an AILS UI widget in the target application UI, access from the target application to the legacy application; locking login to the legacy application; routing user requests to complete open transactions to the legacy application by UI embedding; routing navigation to documents originating from the legacy application to the legacy application with UI embedding; and aggregating, as aggregated data and using an AILS request distribution and response aggregation module, transaction query data from the target application and the legacy application, wherein the aggregated data is displayed on the target application UI.
A fourth feature, combinable with any of the previous or following features, wherein closing usage of the legacy application for changes, comprises: configuring the AILS legacy data access module to send requests to the legacy application; and configuring the AILS UI widget to not provide UI navigation to the legacy application for change operations.
A fifth feature, combinable with any of the previous or following features, comprising: configuring the legacy application to read-only configuration, wherein the configuration is reflected at least in a legacy application UI and incoming application programming interface (API) calls.
A sixth feature, combinable with any of the previous or following features, comprising: determining that data from the legacy application is no longer needed.

In a second implementation, a non-transitory, computer-readable medium storing one or more instructions executable by a computer system to perform one or more operations for clean slate application transformation with transparent legacy system access, comprising: configuring an access and integrate legacy system (AILS) legacy data access module for access to a legacy application; triggering master data migration of a required subset of master data to a target application; switching, using the AILS legacy data access module and an AILS user interface (UI) widget in a target application UI, usage to the target application; closing, using the AILS legacy data access module and the AILS UI widget, usage of the legacy application for changes; and decommissioning the legacy application.

The foregoing and other described implementations can each, optionally, include one or more of the following features:
A first feature, combinable with any of the following features, comprising: receiving access to the target application; preparing the target application for production use; and configuring the target application as if a first-time onboarding without consideration of the legacy application.
A second feature, combinable with any of the previous or following features, comprising: during master data migration of a required subset of master data to a target application, locking the required subset of master data in the legacy application against change.
A third feature, combinable with any of the previous or following features, wherein switching usage to the target application, comprises: opening, in the target application, master data for maintenance; providing, using the AILS legacy data access module and an AILS UI widget in the target application UI, access from the target application to the legacy application; locking login to the legacy application; routing user requests to complete open transactions to the legacy application by UI embedding; routing navigation to documents originating from the legacy application to the legacy application with UI embedding; and aggregating, as aggregated data and using an AILS request distribution and response aggregation module, transaction query data from the target application and the legacy application, wherein the aggregated data is displayed on the target application UI.
A fourth feature, combinable with any of the previous or following features, wherein closing usage of the legacy application for changes, comprises: configuring the AILS legacy data access module to send requests to the legacy application; and configuring the AILS UI widget to not provide UI navigation to the legacy application for change operations.
A fifth feature, combinable with any of the previous or following features, comprising: configuring the legacy application to read-only configuration, wherein the configuration is reflected at least in a legacy application UI and incoming application programming interface (API) calls.
A sixth feature, combinable with any of the previous or following features, comprising: determining that data from the legacy application is no longer needed.

In a third implementation, a computer-implemented system for clean slate application transformation with transparent legacy system access, comprising: one or more computers; and one or more computer memory devices interoperably coupled with the one or more computers and having tangible, non-transitory, machine-readable media storing one or more instructions that, when executed by the one or more computers, perform one or more operations, comprising: configuring an access and integrate legacy system (AILS) legacy data access module for access to a legacy application; triggering master data migration of a required subset of master data to a target application; switching, using the AILS legacy data access module and an AILS user interface (UI) widget in a target application UI, usage to the target application; closing, using the AILS legacy data access module and the AILS UI widget, usage of the legacy application for changes; and decommissioning the legacy application.

The foregoing and other described implementations can each, optionally, include one or more of the following features:
A first feature, combinable with any of the following features, comprising: receiving access to the target application; preparing the target application for production use; and configuring the target application as if a first-time onboarding without consideration of the legacy application.
A second feature, combinable with any of the previous or following features, comprising: during master data migration of a required subset of master data to a target application, locking the required subset of master data in the legacy application against change.
A third feature, combinable with any of the previous or following features, wherein switching usage to the target application, comprises: opening, in the target application, master data for maintenance; providing, using the AILS legacy data access module and an AILS UI widget in the target application UI, access from the target application to the legacy application; locking login to the legacy application; routing user requests to complete open transactions to the legacy application by UI embedding; routing navigation to documents originating from the legacy application to the legacy application with UI embedding; and aggregating, as aggregated data and using an AILS request distribution and response aggregation module, transaction query data from the target application and the legacy application, wherein the aggregated data is displayed on the target application UI.
A fourth feature, combinable with any of the previous or following features, wherein closing usage of the legacy application for changes, comprises: configuring the AILS legacy data access module to send requests to the legacy application; and configuring the AILS UI widget to not provide UI navigation to the legacy application for change operations.
A fifth feature, combinable with any of the previous or following features, comprising: configuring the legacy application to read-only configuration, wherein the configuration is reflected at least in a legacy application UI and incoming application programming interface (API) calls.
A sixth feature, combinable with any of the previous or following features, comprising: determining that data from the legacy application is no longer needed.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for clean slate application transformation with transparent legacy system access, comprising:
configuring an access and integrate legacy system (AILS) legacy data access module for access to a legacy application;
triggering master data migration of a required subset of master data to a target application;
switching, using the AILS legacy data access module and an AILS user interface (UI) widget in a target application UI, usage to the target application;
closing, using the AILS legacy data access module and the AILS UI widget, usage of the legacy application for changes; and
decommissioning the legacy application.

2. The computer-implemented method of claim 1, comprising:
receiving access to the target application;
preparing the target application for production use; and
configuring the target application as if a first-time onboarding without consideration of the legacy application.

3. The computer-implemented method of claim 1, comprising:
during master data migration of a required subset of master data to a target application, locking the required subset of master data in the legacy application against change.

4. The computer-implemented method of claim 1, wherein switching usage to the target application, comprises:
opening, in the target application, master data for maintenance;
providing, using the AILS legacy data access module and an AILS UI widget in the target application UI, access from the target application to the legacy application;
locking login to the legacy application;
routing user requests to complete open transactions to the legacy application by UI embedding;
routing navigation to documents originating from the legacy application to the legacy application with UI embedding; and
aggregating, as aggregated data and using an AILS request distribution and response aggregation module, transaction query data from the target application and the legacy application, wherein the aggregated data is displayed on the target application UI.

5. The computer-implemented method of claim 1, wherein closing usage of the legacy application for changes, comprises:
configuring the AILS legacy data access module to send requests to the legacy application; and
configuring the AILS UI widget to not provide UI navigation to the legacy application for change operations.

6. The computer-implemented method of claim 5, comprising:
configuring the legacy application to read-only configuration, wherein the configuration is reflected at least in a legacy application UI and incoming application programming interface (API) calls.

7. The computer-implemented method of claim 1, comprising:
determining that data from the legacy application is no longer needed.

8. A non-transitory, computer-readable medium storing one or more instructions executable by a computer system to perform one or more operations for clean slate application transformation with transparent legacy system access, comprising:
configuring an access and integrate legacy system (AILS) legacy data access module for access to a legacy application;
triggering master data migration of a required subset of master data to a target application;
switching, using the AILS legacy data access module and an AILS user interface (UI) widget in a target application UI, usage to the target application;
closing, using the AILS legacy data access module and the AILS UI widget, usage of the legacy application for changes; and
decommissioning the legacy application.

9. The non-transitory, computer-readable medium of claim 8, comprising:
receiving access to the target application;
preparing the target application for production use; and
configuring the target application as if a first-time onboarding without consideration of the legacy application.

10. The non-transitory, computer-readable medium of claim 8, comprising:
during master data migration of a required subset of master data to a target application, locking the required subset of master data in the legacy application against change.

11. The non-transitory, computer-readable medium of claim 8, wherein switching usage to the target application, comprises:
opening, in the target application, master data for maintenance;
providing, using the AILS legacy data access module and an AILS UI widget in the target application UI, access from the target application to the legacy application;
locking login to the legacy application;
routing user requests to complete open transactions to the legacy application by UI embedding;
routing navigation to documents originating from the legacy application to the legacy application with UI embedding; and
aggregating, as aggregated data and using an AILS request distribution and response aggregation module, transaction query data from the target application and the legacy application, wherein the aggregated data is displayed on the target application UI.

12. The non-transitory, computer-readable medium of claim 8, wherein closing usage of the legacy application for changes, comprises:
configuring the AILS legacy data access module to send requests to the legacy application; and
configuring the AILS UI widget to not provide UI navigation to the legacy application for change operations.

13. The non-transitory, computer-readable medium of claim 12, comprising:
configuring the legacy application to read-only configuration, wherein the configuration is reflected at least in a legacy application UI and incoming application programming interface (API) calls.

14. The non-transitory, computer-readable medium of claim 8, comprising:
determining that data from the legacy application is no longer needed.

15. A computer-implemented system for clean slate application transformation with transparent legacy system access, comprising:
one or more computers; and
one or more computer memory devices interoperably coupled with the one or more computers and having tangible, non-transitory, machine-readable media storing one or more instructions that, when executed by the one or more computers, perform one or more operations, comprising:
configuring an access and integrate legacy system (AILS) legacy data access module for access to a legacy application;
triggering master data migration of a required subset of master data to a target application;
switching, using the AILS legacy data access module and an AILS user interface (UI) widget in a target application UI, usage to the target application;
closing, using the AILS legacy data access module and the AILS UI widget, usage of the legacy application for changes; and
decommissioning the legacy application.

16. The computer-implemented system of claim 15, comprising:
receiving access to the target application;
preparing the target application for production use; and
configuring the target application as if a first-time onboarding without consideration of the legacy application.

17. The computer-implemented system of claim 15, comprising:
during master data migration of a required subset of master data to a target application, locking the required subset of master data in the legacy application against change.

18. The computer-implemented system of claim 15, wherein switching usage to the target application, comprises:
opening, in the target application, master data for maintenance;
providing, using the AILS legacy data access module and an AILS UI widget in the target application UI, access from the target application to the legacy application;
locking login to the legacy application;
routing user requests to complete open transactions to the legacy application by UI embedding;
routing navigation to documents originating from the legacy application to the legacy application with UI embedding; and
aggregating, as aggregated data and using an AILS request distribution and response aggregation module, transaction query data from the target application and the legacy application, wherein the aggregated data is displayed on the target application UI.

19. The computer-implemented system of claim 15, wherein closing usage of the legacy application for changes, comprises:
configuring the AILS legacy data access module to send requests to the legacy application; and
configuring the AILS UI widget to not provide UI navigation to the legacy application for change operations.

20. The computer-implemented system of claim 19, comprising:
configuring the legacy application to read-only configuration, wherein the configuration is reflected at least in a legacy application UI and incoming application programming interface (API) calls.
